(19) United States
(12) Patent Application Publication
(10) Pub. No.: US 2024/0110320 A1
(43) Pub. Date: Apr. 4, 2024

(54) SYSTEMS AND METHODS USING IMAGE RECOGNITION PROCESSES OR DETERMINED DEVICE ORIENTATION FOR IMPROVED OPERATION OF A LAUNDRY APPLIANCE

(71) Applicant: Haier US Appliance Solutions, Inc., Wilmington, DE (US)

(72) Inventors: Khalid Jamal Mashal, Louisville, KY (US); Myunggeon Chung, Seoul (KR); Suzy Kwak, Seoul (KR); Hyeonsoo Moon, Seoul (KR); Je Kwon Yoon, Hwaseong (KR)

(21) Appl. No.: 17/957,746

(22) Filed: Sep. 30, 2022

(51) Int. Cl. D06F 33/37; G06T 7/70

(52) U.S. Cl. CPC D06F 33/37; G06T 7/70

(57) ABSTRACT

A washing machine appliance or method of the same may include obtaining one or more images of a container in which a wash additive is stowed from a camera assembly of a remote device spaced apart from a cabinet of the washing machine appliance. The method may also include determining a position of the remote device relative to the container and analyzing an obtained image of the one or more images using an image recognition process to identify the wash additive. The method may further include directing a wash cycle within the washing machine appliance based on the identified wash additive.

### FIELD OF THE INVENTION

The present subject matter relates generally to washing machine appliance, and more particularly to appliances and methods with smart wash additive dispense capability.

### BACKGROUND OF THE INVENTION

Washing machine appliances can use a variety of wash additives (e.g., a detergent, fabric softener, or bleach) in addition to water to assist with washing and rinsing a load of articles. For example, detergents or stain removers may be added during wash and prewash cycles of washing machine appliances. As another example, fabric softeners may be added during rinse cycles of washing machine appliances. Wash additives are preferably introduced at an appropriate time during the operation of washing machine appliance and in a proper volume. By way of example, adding insufficient volumes of either the detergent or the fabric softener to the laundry load can negatively affect washing machine appliance operations by diminishing efficacy of a cleaning operation. Similarly, adding excessive volumes of either the detergent or the fabric softener can also negatively affect washing machine appliance operations by diminishing efficacy of a cleaning operation.

Dispensing the proper volume of wash additives has been challenging, for instance, due to variations in concentration or viscosity in wash additives on the market. Different types of detergents often recommend wildly different volumes for cleaning similar load sizes or water volumes. Conventionally, wash additives, such as detergent, have been dispensed based on an “activation time” or “on time” of a component of the washing machine appliance, such as e.g., a dosing pump or a water inlet valve. Despite the wide ranging differences between different wash additives, the “activation time” is generally not modified or altered. Accordingly, many appliances suffer from poor dispensing performance or may require high levels of user intervention to improve performance.

Attempts have been made to automatically (e.g., without direct user input or estimations) detect certain attributes of a wash additive using system or assemblies mounted to a laundry appliance. Unfortunately, though, such systems may increase the expense and complexity of an appliance. Moreover, it can be difficult for a user to know if or when any detected attributes have been detected accurately or correctly.

Accordingly, washing machine appliances and methods for operating such washing machine appliances that address one or more of the challenges noted above would be useful. In particular, it may be advantageous to provide an appliance or method that can account for changes in wash additives. More specifically, a system and method for automatically detecting a wash additive and determining preferred operating parameters would be particularly beneficial, especially if such systems or methods could be achieved without requiring additional or dedicated sensing assemblies to be installed on the washing machine appliance. Further additionally or alternatively, it may be beneficial to provide a system or method wherein a user could be confident that a wash additive is detected in the correct manner (e.g., to ensure accuracy of such detections).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a washing machine appliance is provided. The method may include obtaining one or more images of a container in which a wash additive is stowed from a camera assembly of a remote device spaced apart from a cabinet of the washing machine appliance. The method may also include determining a position of the remote device relative to the container and analyzing an obtained image of the one or more images using an image recognition process to identify the wash additive. The method may further include directing a wash cycle within the washing machine appliance based on the identified wash additive.

In another exemplary aspect of the present disclosure, a method of operating a washing machine appliance is provided. The method may include obtaining one or more images of a container in which a wash additive is stowed from a camera assembly of a remote device spaced apart from a cabinet of the washing machine appliance. Obtaining one or more images may include receiving a video signal from the camera assembly. The method may also include determining a position of the remote device relative to the container and presenting a real-time feed of the camera assembly at the remote device according to the received video signal. The method may further include displaying movement guidance with the real-time feed to guide the remote device. The method may still further include analyzing an obtained image of the one or more images using an image recognition process to identify the wash additive subsequent to determining the position of the remote device. The method may yet further include directing a wash cycle within the washing machine appliance based on the identified wash additive.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter with a door of the exemplary washing machine appliance shown in a closed position.

FIG. 2 provides a perspective view of the exemplary washing machine appliance of FIG. 1 with the door of the exemplary washing machine appliance shown in an open position.

FIG. 3 provides a side cross-sectional view of the exemplary washing machine appliance of FIG. 1.

FIGS. 4A, 4B, 4C provide views illustrating steps of identifying a wash additive according to exemplary embodiments of the present disclosure.

FIG. 5 provides a flow chart illustrating a method of operating a washing machine appliance according to exemplary embodiments of the present disclosure.

FIG. 6 provides a flow chart illustrating a method of operating a washing machine appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

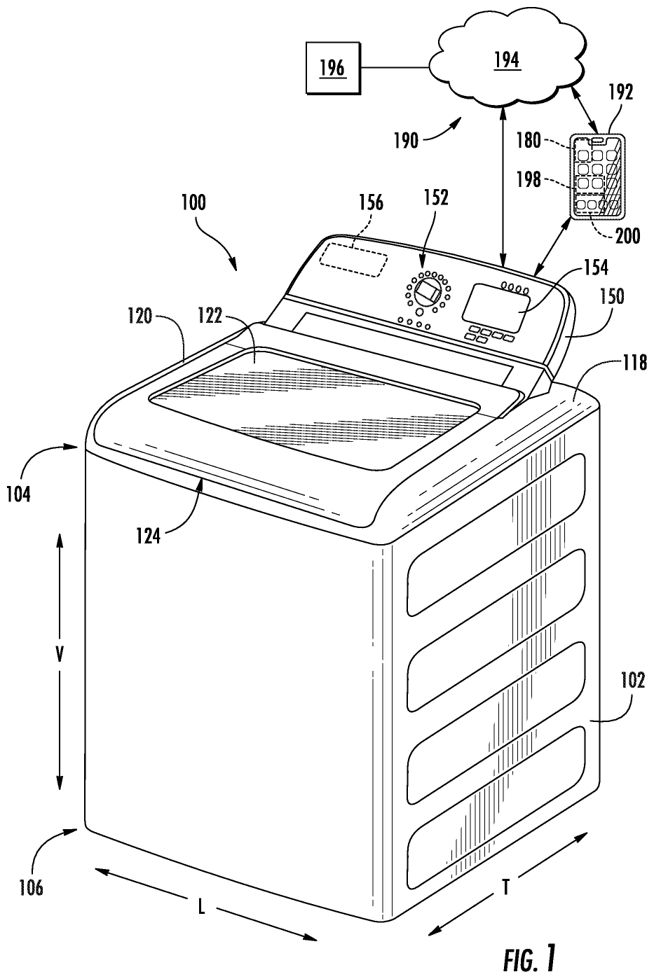

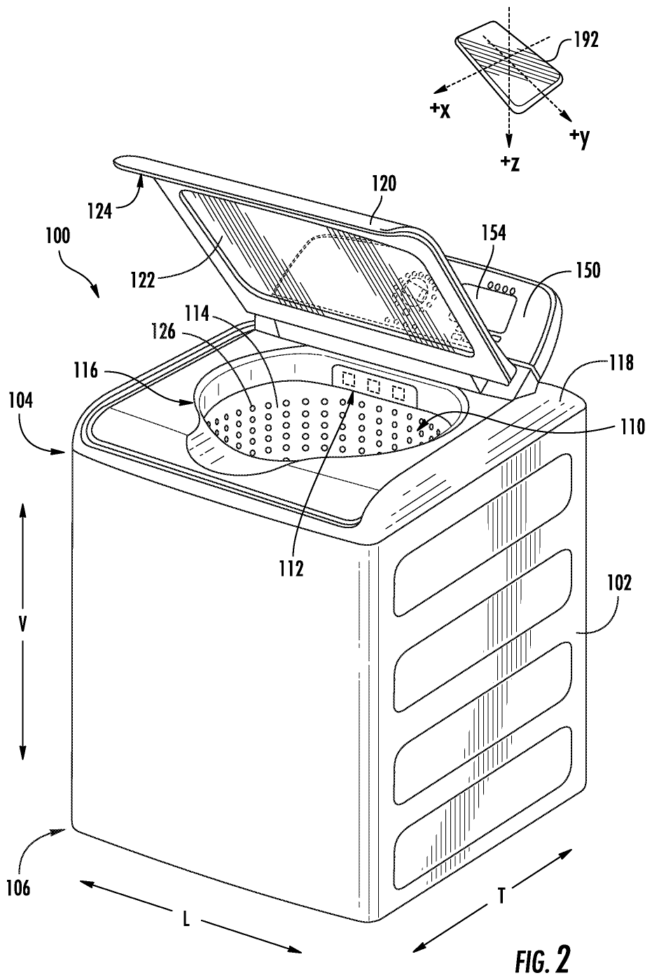

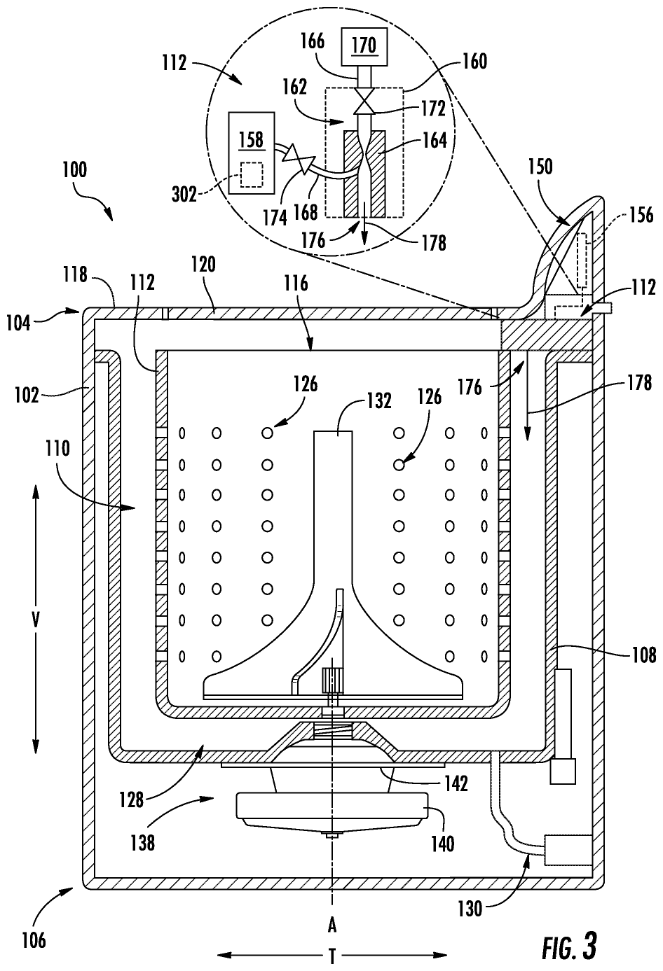

Turning now to the figures, FIGS. 1 through 3 illustrate an exemplary embodiment of a vertical axis washing machine appliance 100. Specifically, FIGS. 1 and 2 illustrate perspective views of washing machine appliance 100 in a closed and an open position, respectively. FIG. 3 provides a side cross-sectional view of washing machine appliance 100. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, it should be appreciated that vertical axis washing machine appliance 100 is provided by way of example only. It will be understood that aspects of the present subject matter may be used in any other suitable washing machine appliance, such as a horizontal axis washing machine appliance. Indeed, modifications and variations may be made to washing machine appliance 100, including different configurations, different appearances, or different features while remaining within the scope of the present subject matter.

Washing machine appliance 100 has a cabinet 102 that extends between a top portion 104 and a bottom portion 106 along the vertical direction V, between a first side (left) and a second side (right) along the lateral direction L, and between a front and a rear along the transverse direction T. As best shown in FIG. 3, a wash tub 108 is positioned within cabinet 102, defines a wash chamber 110, and is generally configured for retaining wash fluids during an operating cycle. Washing machine appliance 100 further includes a primary dispenser or dispensing assembly 112 (FIG. 2) for dispensing wash fluid into wash tub 108.

In addition, washing machine appliance 100 includes a wash basket 114 that is positioned within wash tub 108 and generally defines an opening 116 for receipt of articles for washing. More specifically, wash basket 114 is rotatably mounted within wash tub 108 such that it is rotatable about an axis of rotation A. According to the illustrated embodiment, the axis of rotation A is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

As illustrated, cabinet 102 of washing machine appliance 100 has a top panel 118. Top panel 118 defines an opening (FIG. 2) that coincides with opening 116 of wash basket 114 to permit a user access to wash basket 114. Washing machine appliance 100 further includes a door 120 which is rotatably mounted to top panel 118 to permit selective access to opening 116. In particular, door 120 selectively rotates between the closed position (as shown in FIGS. 1 and 3) and the open position (as shown in FIG. 2). In the closed position, door 120 inhibits access to wash basket 114. Conversely, in the open position, a user can access wash basket 114. A window 122 in door 120 permits viewing of wash basket 114 when door 120 is in the closed position, e.g., during operation of washing machine appliance 100. Door 120 also includes a handle 124 that, e.g., a user may pull or lift when opening and closing door 120. Further, although door 120 is illustrated as mounted to top panel 118, door 120 may alternatively be mounted to cabinet 102 or any other suitable support.

As best shown in FIGS. 2 and 3, wash basket 114 further defines a plurality of perforations 126 to facilitate fluid communication between an interior of wash basket 114 and wash tub 108. In this regard, wash basket 114 is spaced apart from wash tub 108 to define a space for wash fluid to escape wash chamber 110. During a spin cycle, wash fluid within articles of clothing and within wash chamber 110 is urged through perforations 126 wherein it may collect in a sump 128 defined by wash tub 108. Washing machine appliance 100 further includes a pump assembly 130 (FIG. 3) that is located beneath wash tub 108 and wash basket 114 for gravity assisted flow when draining wash tub 108.

An impeller or agitation element 132 (FIG. 3), such as a vane agitator, impeller, auger, oscillatory basket mechanism, or some combination thereof is disposed in wash basket 114 to impart an oscillatory motion to articles and liquid in wash basket 114. More specifically, agitation element 132 extends into wash basket 114 and assists agitation of articles disposed within wash basket 114 during operation of washing machine appliance 100, e.g., to facilitate improved cleaning. In different embodiments, agitation element 132 includes a single action element (i.e., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 are oriented to rotate about axis of rotation A (which is substantially parallel to vertical direction V).

As best illustrated in FIG. 3, washing machine appliance 100 includes a drive assembly or motor assembly 138 in mechanical communication with wash basket 114 to selectively rotate wash basket 114 (e.g., during an agitation or a rinse cycle of washing machine appliance 100). In addition, motor assembly 138 may also be in mechanical communication with agitation element 132. In this manner, motor assembly 138 may be configured for selectively rotating or oscillating wash basket 114 or agitation element 132 during various operating cycles of washing machine appliance 100.

More specifically, motor assembly 138 may generally include one or more of a drive motor 140 and a transmission assembly 142, e.g., such as a clutch assembly, for engaging and disengaging wash basket 114 or agitation element 132. According to the illustrated embodiment, drive motor 140 is a brushless DC electric motor, e.g., a pancake motor. However, according to alternative embodiments, drive motor 140 may be any other suitable type or configuration of motor. For example, drive motor 140 may be an AC motor, an induction motor, a permanent magnet synchronous motor, or any other suitable type of motor. In addition, motor assembly 138 may include any other suitable number, types, and configurations of support bearings or drive mechanisms.

Referring still to FIGS. 1 through 3, a control panel 150 with at least one input selector 152 (FIG. 1) extends from top panel 118. Control panel 150 and input selector 152 collectively form a user interface input for operator selection of machine cycles and features. A display 154 of control panel 150 indicates selected features, operation mode, a countdown timer, or other items of interest to appliance users regarding operation.

Operation of washing machine appliance 100 is controlled by a controller or processing device 156 that is operatively coupled to control panel 150 for user manipulation to select washing machine cycles and features. In response to user manipulation of control panel 150, controller 156 operates the various components of washing machine appliance 100 to execute selected machine cycles and features. According to an exemplary embodiment, controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog or digital logic circuitry (such as switches, amplifiers, integrators, comparators, flip-flops, AND gates, and the like) to perform control functionality instead of relying upon software. Control panel 150 and other components of washing machine appliance 100 may be in communication with controller 156 via one or more signal lines or shared communication busses.

During operation of washing machine appliance 100, laundry items are loaded into wash basket 114 through opening 116, and washing operation is initiated through operator manipulation of input selectors 152. Wash basket 114 is filled with water and detergent or other fluid additives via primary dispenser 112. One or more valves can be controlled by washing machine appliance 100 to provide for filling wash tub 108 and wash basket 114 to the appropriate level for the amount of articles being washed or rinsed. By way of example for a wash mode, once wash basket 114 is properly filled with fluid, the contents of wash basket 114 can be agitated (e.g., with agitation element 132 as discussed previously) for washing of laundry items in wash basket 114.

Referring again to FIGS. 2 and 3, dispensing assembly 112 of washing machine appliance 100 will be described in more detail. As explained briefly above, dispensing assembly 112 may generally be configured to dispense wash fluid to facilitate one or more operating cycles or phases of an operating cycle (e.g., such as a wash cycle or a rinse cycle). The terms “wash fluid” and the like may be used herein to generally refer to a liquid used for washing or rinsing clothing or other articles. For example, the wash fluid is typically made up of water that may include other additives such as detergent, fabric softener, bleach, or other suitable treatments (including combinations thereof). More specifically, the wash fluid for a wash cycle may be a mixture of water, detergent, or other additives, while the wash fluid for a rinse cycle may be water only.

As best shown schematically in FIG. 3, dispensing assembly 112 may generally include a bulk storage tank or bulk reservoir 158 and a dispenser box 160. More specifically, bulk reservoir 158 may be positioned under top panel 118 and defines an additive reservoir for receiving and storing wash additive. More specifically, according to the illustrated embodiment, bulk reservoir 158 may contain a bulk volume of wash additive (such as detergent or other suitable wash additives) that is sufficient for a plurality of wash cycles of washing machine appliance 100, such as no less than twenty wash cycles, no less than fifty wash cycles, etc. As a particular example, bulk reservoir 158 is configured for containing no less than twenty fluid ounces, no less than three-quarters of a gallon, or about one gallon of wash additive. Optionally, a level detector 302 (e.g., float sensor, conductivity sensor, pressure sensor, reed switch, etc.) configured to detect a volume of liquid within the bulk reservoir 158 may be provided. The level detector 302 may be in operative communication with (i.e., communicatively coupled to) the controller 156. Thus, controller 156 may be configured to detect a level of wash additive within the bulk reservoir (e.g., as one or more discrete levels or as a variable volumetric value).

As will be described in detail below, dispensing assembly 112 may include features for drawing wash additive from bulk reservoir 158 and mixing it with water prior to directing the mixture into wash tub 108 to facilitate a cleaning operation. By contrast, dispensing assembly 112 is also capable of dispensing water only. Thus, dispensing assembly 112 may automatically dispense the desired amount of water with or without a desired amount of wash additive such that a user can avoid filling dispenser box 160 with detergent before each operation of washing machine appliance 100.

For example, as best shown in FIG. 3, washing machine appliance 100 includes an aspirator assembly 162, which is a Venturi-based dispensing system that uses a flow of water to create suction within a Venturi tube to draw in wash additive from bulk reservoir 158 which mixes with the water and is dispensed into wash tub 108 as a concentrated wash fluid preferably having a target volume of wash additive. After the target volume of wash additive is dispensed into wash tub 108, additional water may be provided into wash tub 108 as needed to fill to the desired wash volume. It should be appreciated that the target volume may be preprogrammed in controller 156 according to the selected operating cycle or parameters, may be set by a user, or may be determined in any other suitable manner.

As illustrated, aspirator assembly 162 includes a Venturi pump 164 that is fluidly coupled to both a water supply conduit 166 and a suction line 168. As illustrated, water supply conduit 166 may provide fluid communication between a water supply source 170 (such as a municipal water supply) and a water inlet of Venturi pump 164. In addition, washing machine appliance 100 includes a water fill valve or water control valve 172 which is operably coupled to water supply conduit 166 and is communicatively coupled to controller 156. In this manner, controller 156 may regulate the operation of water control valve 172 to regulate the amount of water that passes through aspirator assembly 162 and into wash tub 108.

In addition, suction line 168 may provide fluid communication between bulk reservoir 158 and Venturi pump 164 (e.g., via a suction port defined on Venturi pump 164). Notably, as a flow of water is supplied through Venturi pump 164 to wash tub 108, the flowing water creates a negative pressure within suction line 168. This negative pressure may draw in wash additive from bulk reservoir 158. When certain conditions exist, the amount of wash additive dispensed is roughly proportional to the amount of time water is flowing through Venturi pump 164.

Referring still to FIG. 3, aspirator assembly 162 may further include a suction valve 174 that is operably coupled to suction line 168 to control the flow of wash additive through suction line 168 when desired. For example, suction valve 174 may be a solenoid valve that is communicatively coupled with controller 156. Controller 156 may selectively open and close suction valve 174 to allow wash additive to flow from bulk reservoir 158 through additive suction valve 174. For example, during a rinse cycle where only water is desired, suction valve 174 may be closed to prevent wash additive from being dispensed through suction valve 174. In some embodiments, suction valve 174 is selectively controlled based on at least one of the selected wash cycle, the soil level of the articles to be washed, and the article type. According to still other embodiments, no suction valve 174 is needed at all and alternative means for preventing the flow of wash additive may be used or other water regulating valves may be used to provide water into wash tub 108.

Washing machine appliance 100, or more particularly, dispensing assembly 112, generally includes a discharge nozzle 176 for directing a flow of wash fluid (e.g., identified herein generally by reference numeral 178) into wash chamber 108. In this regard, discharge nozzle 176 may be positioned above wash tub 108 proximate a rear of opening 116 defined through top panel 118. Dispensing assembly 112 may be regulated by controller 156 to discharge wash fluid 178 through discharge nozzle 176 at the desired flow rates, volumes, or detergent concentrations to facilitate various operating cycles, e.g., such as wash or rinse cycles.

Although water supply conduit 166, water supply source 170, discharge nozzle 176, and water control valve 172 are all described and illustrated herein in the singular form, it should be appreciated that these terms may be used herein generally to describe a supply plumbing for providing hot or cold water into wash chamber 110. In this regard, water supply conduit 166 may include separate conduits for receiving hot and cold water, respectively. Similarly, water supply source 170 may include both hot- and cold-water supplies regulated by dedicated valves. In addition, washing machine appliance 100 may include one or more pressure sensors (not shown) for detecting the amount of water and or clothes within wash tub 108. For example, the pressure sensor may be operably coupled to a side of tub 108 for detecting the weight of wash tub 108, which controller 156 may use to determine a volume of water in wash chamber 110 and a subwasher load weight.

After wash tub 108 is filled and the agitation phase of the wash cycle is completed, wash basket 114 can be drained, e.g., by drain pump assembly 138. Laundry articles can then be rinsed by again adding fluid to wash basket 114 depending on the specifics of the cleaning cycle selected by a user. The impeller or agitation element 132 may again provide agitation within wash basket 114. One or more spin cycles may also be used as part of the cleaning process. In particular, a spin cycle may be applied after the wash cycle or after the rinse cycle in order to wring wash fluid from the articles being washed. During a spin cycle, wash basket 114 is rotated at relatively high speeds to help wring fluid from the laundry articles through perforations 126. During or prior to the spin cycle, drain pump assembly 138 may operate to discharge wash fluid from wash tub 108, e.g., to an external drain. After articles disposed in wash basket 114 are cleaned or washed, the user can remove the articles from wash basket 114, e.g., by reaching into wash basket 114 through opening 116.

Referring still to FIG. 1, a schematic diagram of an external communication system 190 will be described according to an exemplary embodiment of the present subject matter. In general, external communication system 190 is configured for permitting interaction, data transfer, and other communications between washing machine appliance 100 and one or more remote devices. For example, this communication may be used to provide and receive operating parameters, user instructions or notifications, performance characteristics, user preferences, or any other suitable information for improved performance of washing machine appliance 100. In addition, it should be appreciated that external communication system 190 may be used to transfer data or other information to improve performance of one or more remote devices or appliances or improve user interaction with such devices.

For example, external communication system 190 permits controller 156 of washing machine appliance 100 to communicate with a separate device external to washing machine appliance 100, referred to generally herein as a remote device 192. As described in more detail below, these communications may be facilitated using a wired or wireless connection, such as via a network 194. In general, remote device 192 may be any suitable device separate from washing machine appliance 100 that is configured to provide or receive communications, information, data, or commands from a user. In this regard, remote device 192 may be, for example, a personal phone, a smartphone, a tablet, a laptop or personal computer, a wearable device, a smart home system, or another mobile or remote device.

In some embodiments, remote user device 192 includes a camera or camera module 180. Camera 180 may be any type of device suitable for capturing a two-dimensional picture or image. As an example, camera 180 may be a video camera or a digital camera with an electronic image sensor [e.g., a charge coupled device (CCD) or a CMOS sensor]. When assembled, camera 180 is generally mounted or fixed to a body of remote user device 192 and is communicatively coupled to (e.g., in electric or wireless communication with) a controller 198 of the remote user device 192 such that the controller 156 (or a processor of a remote server 196) may receive a signal from camera 180 corresponding to the image captured by camera 180.

Generally, remote device 192 may include a controller 198 (e.g., including one or more suitable processing devices, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. Controller 198 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor of controller 198 or may be included onboard within such processor. In addition, these memory devices can store information or data accessible by the one or more processors of the controller 198, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 198 may be operable to execute programming instructions or micro-control code associated with operation of or engagement with washing machine appliance 100. In this regard, the instructions may be software or any set of instructions that when executed by the processing device, cause the processing device to perform operations, such as running one or more software applications, displaying or directing a user interface, receiving user input, processing user input, etc. Moreover, it should be noted that controller 198 as disclosed herein is capable of and may be operable to perform one or more methods, method steps, or portions of methods of appliance operation. For example, in some embodiments, these methods may be embodied in programming instructions stored in the memory and executed by controller 198.

The memory devices of controller 198 may also store data that can be retrieved, manipulated, created, or stored by the one or more processors or portions of controller 156. The data can include, for instance, data to facilitate performance of methods described herein. store data that can be retrieved, manipulated, created, or stored by the one or more processors or portions of controller 198. The data can include, for instance, data to facilitate performance of methods described herein.

In certain embodiments, a measurement device 200 may be included with or connected to controller 198 on remote device 192. Moreover, measurement devices 200 may include a microprocessor that performs the calculations specific to the measurement of position or movement with the calculation results being used by controller 198. Generally, measurement device 200 may detect a plurality of angle readings. For instance, multiple angle readings may be detected simultaneously to track multiple (e.g., mutually orthogonal) axes of the remote device 192, such as an X-axis, Y-axis, and Z-axis shown in FIG. 2. For instance, the axes may be detected or tracked relative to gravity and, thus, the installed washing machine appliance 100. Optionally, a measurement device 200 may be or include an accelerometer, which measures, at least in part, the effects of gravity (e.g., as an acceleration component), such as acceleration along one or more predetermined directions. Additionally or alternatively, a measurement device 200 may be or include a gyroscope, which measures rotational positioning (e.g., as a rotation component).

A measurement device 200 in accordance with the present disclosure can be mounted on or within the remote device 192, as required to sense movement or position of remote device 192 relative to the cabinet 102 of appliance 100. Optionally, measurement device 200 may include at least one gyroscope or at least one accelerometer. The measurement device 200, for example, may be a printed circuit board which includes the gyroscope and accelerometer thereon.

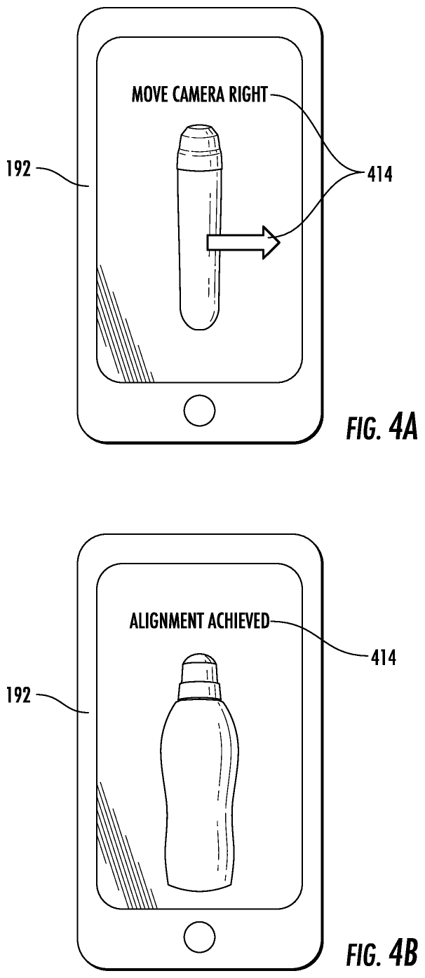

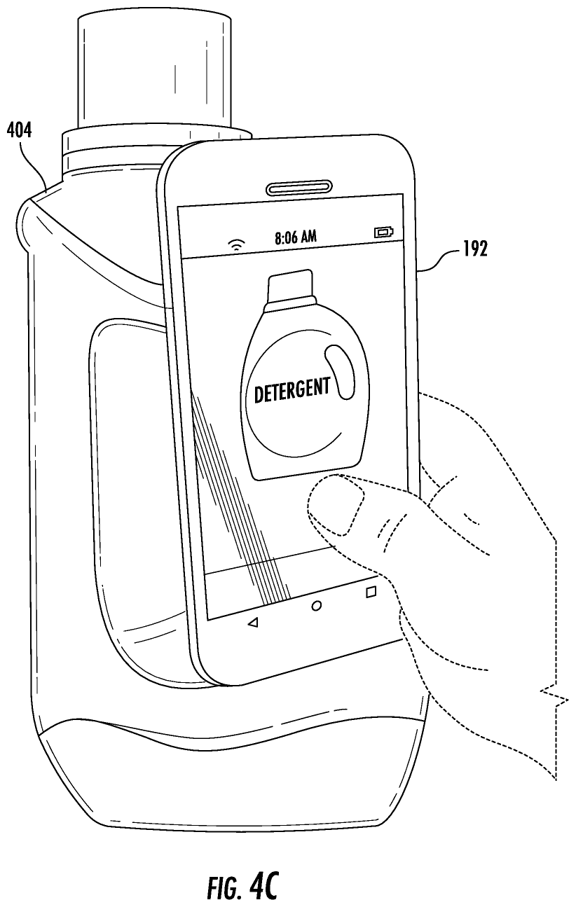

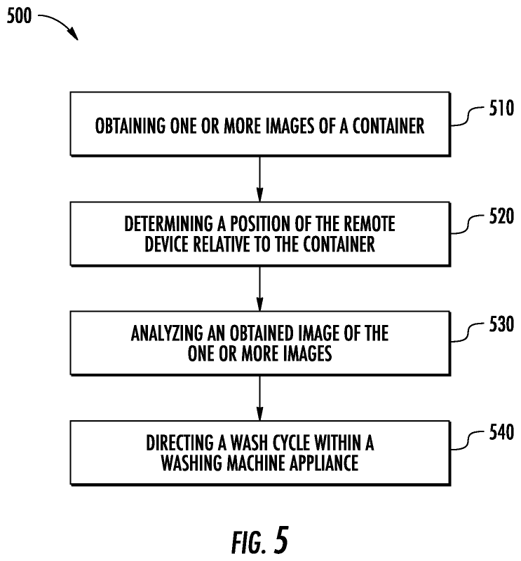

Turning briefly to FIGS. 4A, 4B, and 4C, the data on controller 198 may include identifying information to identify or detect a wash additive from one or more images. For instance, a remote device 192 may be used to capture an image of an additive container 404 or container in which the wash additive loaded or to be loaded within washing machine appliance 100 is stowed. Thus, a user may present the container proximate remote device 192 (or another suitable image capture device) so that camera 180 (FIG. 1) may capture the image of the container 404. Based on the captured image of the container, a controller (e.g., 156, 198, or a processor on remote server 196) can identify the wash additive, e.g., by using image recognition module or software. Additionally or alternatively, remote device 192 may capture the image of the wash additive itself. Based on the captured image of the wash additive, a controller (e.g., 156, 198, or a processor on remote server 196) can identify the wash additive, e.g., by using image recognition module or software.

In some embodiments, controller 198 may be configured to direct a presentation or display of a real-time feed from the camera 180 (e.g., on the monitor or display screen of the remote device 192). Optionally, movement guidance 414 (e.g., in the form of pictorial or textual instructions, such as arrows or written messages) may be displayed such that a user can properly align the camera 180 (e.g., relative to the additive container 404) to capture an image that may be further analyzed (e.g., to identify the wash additive).

Returning to FIG. 1, a remote server 196 may be in communication with (i.e., communicatively coupled to) washing machine appliance 100 or remote device 192 through network 194. In this regard, for example, remote server 196 may be a cloud-based server 196, and is thus located at a distant location, such as in a separate state, country, etc. According to an exemplary embodiment, remote device 192 may communicate with a remote server 196 over network 194, such as the Internet, to transmit/receive data or information, provide user inputs, receive user notifications or instructions, interact with or control washing machine appliance 100, etc. In addition, remote device 192 and remote server 196 may communicate with washing machine appliance 100 to communicate similar information.

In general, communication between washing machine appliance 100, remote device 192, remote server 196, or other user devices or appliances may be carried using any type of wired or wireless connection and using any suitable type of communication network, non-limiting examples of which are provided below. For example, remote device 192 may be in direct or indirect communication with washing machine appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, or different features may also be utilized with the present subject matter as well, e.g., horizontal axis washing machine appliances. In addition, aspects of the present subject matter may be utilized in a combination washer/dryer appliance.

Now that the construction of washing machine appliance 100 and the configuration of controller(s) 156, 198 according to exemplary embodiments have been presented, exemplary methods (e.g., methods 500 and 600) of operating a washing machine appliance will be described. Although the discussion below refers to the exemplary methods 500 and 600 of operating washing machine appliance 100, one skilled in the art will appreciate that the exemplary methods 500 and 600 are applicable to the operation of a variety of other washing machine appliances, such as vertical axis washing machine appliances. In exemplary embodiments, the various method steps as disclosed herein may be performed (e.g., in whole or part) by controller 156, controller 198, or another, separate controller (e.g., on remote server 196).

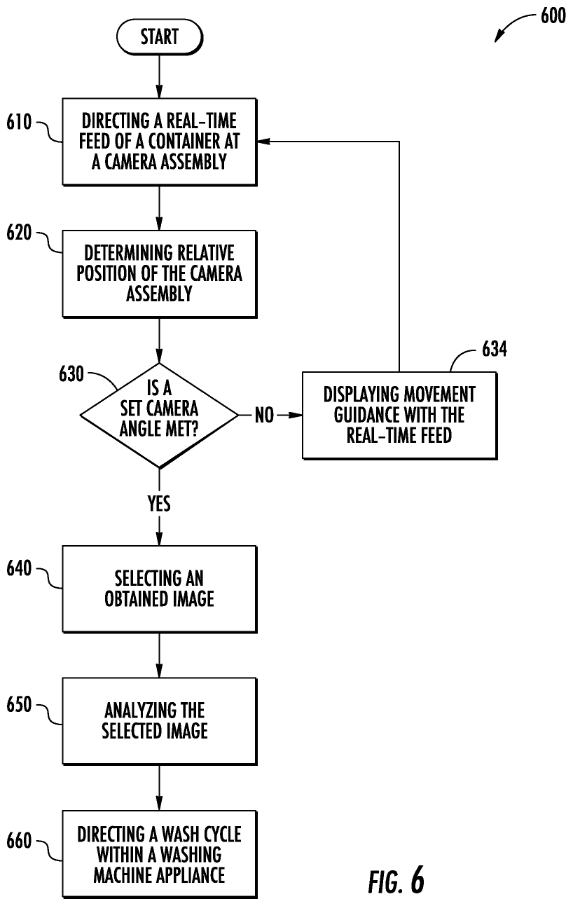

FIGS. 5 and 6 depict steps performed in a particular order for purpose of illustration and discussion. Those of ordinary skill in the art, using the disclosures provided herein, will understand that (except as otherwise indicated) methods 500 and 600 are not mutually exclusive. Moreover, the steps of the methods 500 and 600 can be modified, adapted, rearranged, omitted, interchanged, or expanded in various ways without deviating from the scope of the present disclosure.

Advantageously, methods in accordance with the present disclosure may permit effective or efficient dispensing of a wash additive (e.g., without requiring direct user knowledge or calculations). Additionally or alternatively, methods or dispensing may permit a wash additive to be automatically and accurately determined (e.g., such as to ensure an appropriate amount of the additive is used during a wash cycle). Further additionally or alternatively, a user may be advantageously guided to ensure consistent and accurate images are gathered to, in turn, ensure accuracy of any further determinations.

Turning especially to FIG. 5, at 510, the method 500 includes obtaining one or more images of a container from a camera assembly, such as may be provided on a remote device (i.e., external device). For instance, the camera of the remote device may be aimed at the container stowing a wash additive, as illustrated in FIGS. 4A, 4B, and 4C. In turn, such images may include or capture a two-dimensional image of an additive container.

It should be appreciated that obtaining the images may include obtaining more than one image, a series of frames, a video, or any other suitable visual representation of the wash additive using the camera assembly of the remote device. Thus, 510 may include receiving a video signal from the camera assembly. Separate from or in addition to the video signal, the images obtained by the camera assembly may vary in number, frequency, angle, resolution, detail, etc. in order to improve the clarity of the container. In addition, the obtained images may also be cropped in any suitable manner for improved focus on desired portions of the container.

In optional embodiments, the obtained images can be presented or displayed as a real-time feed of the camera assembly at the remote device (e.g., according to the received video signal). For instant, a constant or regularly refreshing set of live images from the camera assembly may be presented on the monitor or screen of the remote device. Thus, a user viewing the remote device may be able to see the field of view being captured by the camera assembly (e.g., without having to repeatedly freeze the frame or provide any active input by a user on the remote device).

The one or more images may be obtained using the camera assembly at any suitable time prior to initiating a wash cycle.

At 520, the method 500 includes determining a position of a remote device relative to a container. In particular, it may be determined if or when the remote device is appropriately positioned (e.g., based on one or more predetermined factors) relative to the container (e.g., such that the container is suitably oriented within the field of view of the camera of the remote device). For instance, 520 may include determining a set camera angle is met for the camera assembly of the remote device.

In some embodiments, 520 is based on one or more angle readings detected at the remote device. As an example, the method 500 may include receiving a plurality of angle readings from the remote device (e.g., with or simultaneous to 510). Thus, a plurality of angle readings may be obtained (e.g., from a measurement device of the remote device, as described above) to determine the position of the remote device (e.g., relative to a fixed reference direction, axis, or point). Subsequently, the determined position of the remote device may be determined to match the set camera angle, or at least a portion thereof (e.g., within a set tolerance or range, such as 10%).

In additional or alternative embodiments, 520 is based on the one or more images of 510. Specifically, an abbreviated analysis may be performed on one or more of the images to determine container orientation. Optionally, a set reference (e.g., a fiducial element, segment, or profile) from the container may be recognized. The set reference may include a container profile or printed profile (e.g., shape of a portion of text or logo applied to the container, such as may be provided by an identifying trademark). Thus, and as would be understood, the two-dimensional geometry of the set reference captured in an obtained image will vary depending on the angle of the camera when the image is obtained. The set reference may include a two-dimensional reference shape that corresponds to the geometry of the set reference in the set camera angle (e.g., in which images to accurately analyze the container may be obtained).

As an example, a container shape or profile (i.e., the shape of the container) is recognized. Such recognition may include matching a generalized shape or proportion of the container (e.g., as captured within an image) to a predetermined template or reference. From the comparison, it may be determined if the set reference matches the two-dimensional reference shape (e.g., the set reference within the obtained image has dimensions that are within a set tolerance or range of the two-dimensional reference shape, such as 10%). For instance, the size or eccentricity of the set reference within the obtained image may be calculated and compared to the size or eccentricity programmed for the two-dimensional reference shape.

Optionally, multiple set references may be provided (e.g., programmed within a controller). Thus, recognizing the set reference may include comparing a portion of an obtained image (e.g., a recognized container shape or logo) to a plurality of references (e.g., reference shapes) and selecting the set reference from the plurality of references.

As is understood, recognizing or identifying such set references or portions of the container, may be performed by one or more image processing techniques or algorithms (e.g., executed at the controller of the remote device, remote server, or appliance). In some exemplary embodiments, image processing includes optical character recognition (OCR), as is generally understood. According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller of the remote device, remote server, or appliance based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

As part of or in tandem with 520, the method 500 may provide for displaying movement guidance (e.g., in the form of pictorial or textual instructions, such as arrows or written messages) with the real-time feed (e.g., to help a user move the camera to align the remote device with the container). In optional embodiments, a feedback signal is generated (e.g., at the remote device) in response to 520. Such a feedback signal may prompt a feedback action (e.g., visual alert on the monitor, haptic movement at the remote appliance, audio tone, etc.) corresponding to the set camera angle being met such that a user can know further movement of the camera is unnecessary.

Once the set angle is determined to be met or an appropriate position of the camera is otherwise determined (e.g., in response thereto), a particular image or images may be captured (e.g., selected or stored) as an image suitable for analysis at 530 (i.e., “the obtained image”). Optionally, the obtained image may be captured automatically and, thus, without requiring direct intervention or input from a user.

At 530, the method 500 includes analyzing an obtained image of the one or more images using an image recognition process to identify the wash additive. In other words, image recognition process(es) may be applied to the obtained image in order to determine the identify (e.g., brand, style, or other predetermined characteristics of) the wash additive held within the container. The identification may be made by selecting a programmed additive profile from a plurality of additive profiles, each including characteristics or dosing data for the corresponding wash additive. Optionally, the plurality of additive profiles may include a default profile (e.g., to be selected in the event that the image recognition process(es) are unable to meet a recognition threshold for any other profile of the plurality of additive profiles).

Optionally, the method 500 may include selecting the obtained image in response to determining the set camera angle is met at 520. In turn, 530 may be in response to determining the set camera angle is met.

As used herein, the terms image recognition, object detection, and similar terms may be used generally to refer to any suitable method of observation, analysis, image decomposition, feature extraction, image classification, etc. of one or more image or videos taken of the container. It should be appreciated that any suitable image recognition software or process may be used to analyze images taken by the camera assembly and a controller may be programmed to perform such processes and take corrective action.

In certain embodiments, the image analysis may include utilizing artificial intelligence (“AI”), such as a machine learning image recognition process, a neural network classification module, any other suitable artificial intelligence (AI) technique, or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, controller may implement a form of image recognition called region based convolutional neural network (“R-CNN”) image recognition. Generally speaking, R-CNN may include taking an input image and extracting region proposals that include a potential object, such as an item of clothing (e.g., jeans, socks, etc.) or an undesirable article (e.g., a belt, a wallet, etc.). In this regard, a “region proposal” may be regions in an image that could belong to a particular object. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like. It should be appreciated that any other suitable image recognition process may be used while remaining within the scope of the present subject matter.

According to still other embodiments, the image recognition process may use any other suitable neural network process. For example, 530 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image and estimate load size or main load fabric type of the load within the wash basket. In addition, a K-means algorithm may be used for dominant color analysis to find individual color of fabrics to serve with warnings.

According to exemplary embodiments the image recognition process may further include the implementation of Vision Transformer (ViT) techniques or models. In this regard, ViT is generally intended to refer to the use of a vision model based on the Transformer architecture originally designed and commonly used for natural language processing or other text-based tasks. For example, ViT represents an input image as a sequence of image patches and directly predicts class labels for the image. This process may be similar to the sequence of word embeddings used when applying the Transformer architecture to text. The ViT model and other image recognition models described herein may be trained using any suitable source of image data in any suitable quantity. Notably, ViT techniques have been demonstrated to outperform many state-of-the-art neural network or artificial intelligence image recognition processes.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, color detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

At 540, the method 500 includes directing a wash cycle within a washing machine appliance (e.g., based on the identified wash additive). Such direction may require adjusting one or more operating parameters of the washing machine appliance (e.g., as part of the wash cycle, which may then be initiated). Certain characteristics, such as load size, garment type, etc. may be provided in advance (e.g., by a user selection or input). Thus, 540 may include selecting an operating cycle parameter, adjusting a water or detergent fill amount, or providing a user notification. As used herein, an “operating parameter” of the washing machine appliance is any cycle setting, additive dispensing schedule/amount, water dispensing temperature or amount, operating time, component setting, spin speed, part configuration, or other operating characteristic that may affect the performance of the washing machine appliance. In turn, references to operating parameter adjustments or “adjusting at least one operating parameter” are intended to refer to control actions intended to improve system performance based on the load characteristics. For example, adjusting an operating parameter may include adjusting a dispensing schedule or amount of the wash additive, an agitation time or an agitation profile, adjusting a water level, limiting a spin speed of the wash basket, etc. Other operating parameter adjustments are possible and within the scope of the present subject matter.

In certain embodiments, 540 include determining an additive volume. Optionally, a programmed table may be provided (e.g., within one or more controller) in which a plurality of wash additives (e.g., types of detergent) are listed with corresponding additive volumes and load sizes. In other words, for multiple different load sizes, a discrete additive volume may be provided for each of the plurality of wash additives. Thus, the identified wash additive may be referenced (e.g., along with a set load size) to find the corresponding additive volume of wash additive to be dispensed. The additive volume may be selected as a cycle additive volume.

Although described primarily in the context of liquid volumes, it is understood that the above determinations or values may be determined in the context of estimated volumes or activation times (e.g., numbers of pulses) of the dispensing assembly. Thus, a set activation time or number of pulses may be known (e.g., from past or empirical determinations) to dispense a correlated or set volume of wash additive.

After the additive volume is determined, 540 may include dispensing the determined cycle additive volume within the wash tub. In other words, the dispensing assembly may be operated (e.g., as described above) to dispense the determined cycle additive volume. For example, continuing the example from above, the dispensing assembly may be used to provide flow of wash fluid into wash tub to facilitate various operating phases or cycles of washing machine appliance. More particularly, the dispensing assembly may dispense wash fluid that includes a mixture of water and the determined cycle additive volume (e.g., with or without other additives) during a wash phase or cycle.

Further rinse, agitation, or drain cycles may further be provided, as would be understood, until the washing operation is finished.

In some embodiments, the start of the wash cycle at 540 may be contingent on one or more predetermined conditions. As an example, it may be required that a user selects an input to start the wash cycle. As an additional or alternative example, it may be required that a door shuts within a predetermined time period (e.g., less than one minute, such as a period less than or equal to 30 seconds, 15 seconds, or 5 seconds) following 510 or 530 (e.g., measured in response to 510 or 530). For instance, the method 500 may include determining the door of the washing machine appliance is closed or in a closed position following the predetermined time period (e.g., following 510). Such as determination may be based on a signal from the latch assembly or a subsequently received image from the camera assembly. In turn, 540 may be in response to determining the door is closed within the predetermined time period. If the door is not determined to close within the predetermined time period (e.g., determination of the door being closed within the predetermined time period fails), a user may be required to manually input a start signal (e.g., by pressing a button) at the control panel of the washing machine appliance in order to prompt 540.

Turning now especially to FIG. 6, at 610, the method 600 includes directing a real-time video feed of a container (e.g., containing a detergent or other suitable wash additive) at a camera assembly of a remote device. Thus, 610 includes obtaining more than one image, a series of frames, a video, or any other suitable visual representation of the container from the camera assembly or module of a remote device (i.e., external device), such as described above. In turn, 610 may include receiving a video signal from the camera assembly. Separate from or in addition to the video signal, the images obtained by the camera assembly may vary in number, frequency, angle, resolution, detail, etc. in order to improve the clarity of the container. In addition, the obtained images may also be cropped in any suitable manner for improved focus on desired portions of the container.

The obtained images are then presented or displayed as a real-time feed of the camera assembly at the remote device (e.g., according to the received video signal). For instant, a constant or regularly refreshing set of live images from the camera assembly may be presented on the monitor or display of the remote device. Thus, a user viewing the remote device may be able to see the field of view being captured by the camera assembly (e.g., without having to repeatedly freeze the frame or provide any active input by a user on the remote device).

The images may be obtained using the camera assembly at any suitable time prior to initiating the wash cycle. For example, as best illustrated in FIGS. 4A through 4C, the camera of the remote device may be aimed at the container of a wash additive. In turn, such images may include or capture a two-dimensional image of an additive container.

At 620, the method include determining a relative position of the camera assembly. For instance, 620 may include determining a position of a remote device relative to a container.

In some embodiments, 620 is based on one or more angle readings detected at the remote device. As an example, 620 may include receiving a plurality of angle readings from the remote device. Thus, a plurality of angle readings may be obtained (e.g., from a measurement device of the remote device, as described above) to determine the position of the remote device (e.g., relative to a fixed reference direction, axis, or point).

In additional or alternative embodiments, 620 is based on the one or more images of 620. Specifically, an abbreviated analysis may be performed on one or more of the images to determine container orientation. Optionally, a set reference (e.g., a fiducial element, segment, or profile) from the container may be recognized. The set reference may include a container profile or printed profile (e.g., shape of a portion of text or logo applied to the container, such as may be provided by an identifying trademark). Thus, and as would be understood, the two-dimensional geometry of the set reference captured in an obtained image will vary depending on the angle of the camera when the image is obtained. The set reference may include a two-dimensional reference shape that corresponds to the geometry of the set reference in the set camera angle (e.g., in which images to accurately analyze the container may be obtained).

As an example, a container shape or profile (i.e., the shape of the container) is recognized. Such recognition may comparing a generalized shape or proportion of the container (e.g., as captured within an image) to a predetermined template or reference. Optionally, multiple set references may be provided (e.g., programmed within a controller). Thus, recognizing the set reference may include comparing a portion of an obtained image (e.g., a recognized container shape or logo) to a plurality of references (e.g., reference shapes) and selecting the set reference from the plurality of references.

As is understood, recognizing or identifying such set references or portions of the container, may be performed by one or more image processing techniques or algorithms (e.g., executed at the controller of the remote device, remote server, or appliance). In some exemplary embodiments, image processing includes optical character recognition (OCR), as is generally understood. According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller of the remote device, remote server, or appliance based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

At 630, the method 600 includes determining compliance with a set camera angle for the camera assembly of the remote device. In particular, it may be determined if the set camera angle is met.

As an example, the determined position of the remote device based on the angle readings may be determined to match the set camera angle, or at least a portion thereof (e.g., within a set tolerance or range, such as 10%).

As an additional or alternative example, a detected portion of the container may be compared to the two-dimensional reference shape of a set reference. From the comparison, it may be determined if the set reference matches the two-dimensional reference shape (e.g., the set reference within the obtained image has dimensions that are within a set tolerance or range of the two-dimensional reference shape, such as 10%). For instance, the size or eccentricity of the set reference within the obtained image may be calculated and compared to the size or eccentricity programmed for the two-dimensional reference shape.

If the set angle is met, such as may be indicated by using the plurality of angle readings or comparing the set reference the two-dimensional reference shape, the method 600 may proceed to 640. By contrast, if the set angle is not met, the method 600 may proceed to 634 (e.g., before returning to 510).

At 634, the method 600 includes displaying movement guidance (e.g., in the form of pictorial or textual instructions, such as arrows or written messages) with the real-time feed (e.g., to help a user move the camera to align the remote device with the container). In optional embodiments, a feedback signal is generated (e.g., at the remote device) in response to 620. Such a feedback signal may prompt a feedback action (e.g., visual alert on the monitor, haptic movement at the remote appliance, audio tone, etc.) corresponding to the set camera angle being met such that a user can know further movement of the camera is unnecessary.

At 640, the method 600 includes selecting an obtained image. In other words, once the set angle is determined to be met or an appropriate position of the camera is otherwise determined (e.g., in response thereto), a particular image or images may be captured (e.g., selected or stored) as an image suitable for analysis at 650 (i.e., “the obtained image”). Optionally, the obtained image may be captured automatically and, thus, without requiring direct intervention or input from a user.

At 650, the method 600 includes analyzing the obtained image of using an image recognition process to identify the wash additive. In other words, image recognition process(es) may be applied to the obtained image in order to determine the identify (e.g., brand, style, or other predetermined characteristics of) the wash additive held within the container. The identification may be made by selecting a programmed additive profile from a plurality of additive profiles, each including characteristics or dosing data for the corresponding wash additive. Optionally, the plurality of additive profiles may include a default profile (e.g., to be selected in the event that the image recognition process(es) are unable to meet a recognition threshold for any other profile of the plurality of additive profiles).

As used herein, the terms image recognition, object detection, and similar terms may be used generally to refer to any suitable method of observation, analysis, image decomposition, feature extraction, image classification, etc. of one or more image or videos taken of the container. It should be appreciated that any suitable image recognition software or process may be used to analyze images taken by the camera assembly and a controller may be programmed to perform such processes and take corrective action.

In certain embodiments, the image analysis may include utilizing artificial intelligence (“AI”), such as a machine learning image recognition process, a neural network classification module, any other suitable artificial intelligence (AI) technique, or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, controller may implement a form of image recognition called region based convolutional neural network (“R-CNN”) image recognition. Generally speaking, R-CNN may include taking an input image and extracting region proposals that include a potential object, such as an item of clothing (e.g., jeans, socks, etc.) or an undesirable article (e.g., a belt, a wallet, etc.). In this regard, a “region proposal” may be regions in an image that could belong to a particular object. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like. It should be appreciated that any other suitable image recognition process may be used while remaining within the scope of the present subject matter.

According to still other embodiments, the image recognition process may use any other suitable neural network process. For example, 650 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image and estimate load size or main load fabric type of the load within the wash basket. In addition, a K-means algorithm may be used for dominant color analysis to find individual color of fabrics to serve with warnings.

According to exemplary embodiments the image recognition process may further include the implementation of Vision Transformer (ViT) techniques or models. In this regard, ViT is generally intended to refer to the use of a vision model based on the Transformer architecture originally designed and commonly used for natural language processing or other text-based tasks. For example, ViT represents an input image as a sequence of image patches and directly predicts class labels for the image. This process may be similar to the sequence of word embeddings used when applying the Transformer architecture to text. The ViT model and other image recognition models described herein may be trained using any suitable source of image data in any suitable quantity. Notably, ViT techniques have been demonstrated to outperform many state-of-the-art neural network or artificial intelligence image recognition processes.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, color detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

At 660, the method 600 includes directing a wash cycle within a washing machine appliance (e.g., based on the identified wash additive). Such direction may require adjusting one or more operating parameters of the washing machine appliance (e.g., as part of the wash cycle, which may then be initiated). Certain characteristics, such as load size, garment type, etc. may be provided in advance (e.g., by a user selection or input). Thus, 660 may include selecting an operating cycle parameter, adjusting a water or detergent fill amount, or providing a user notification. As used herein, an “operating parameter” of the washing machine appliance is any cycle setting, additive dispensing schedule/amount, water dispensing temperature or amount, operating time, component setting, spin speed, part configuration, or other operating characteristic that may affect the performance of the washing machine appliance. In turn, references to operating parameter adjustments or “adjusting at least one operating parameter” are intended to refer to control actions intended to improve system performance based on the load characteristics. For example, adjusting an operating parameter may include adjusting a dispensing schedule or amount of the wash additive, an agitation time or an agitation profile, adjusting a water level, limiting a spin speed of the wash basket, etc. Other operating parameter adjustments are possible and within the scope of the present subject matter.

In certain embodiments, 660 include determining an additive volume. Optionally, a programmed table may be provided (e.g., within one or more controller) in which a plurality of wash additives (e.g., types of detergent) are listed with corresponding additive volumes and load sizes. In other words, for multiple different load sizes, a discrete additive volume may be provided for each of the plurality of wash additives. Thus, the identified wash additive may be referenced (e.g., along with a set load size) to find the corresponding additive volume of wash additive to be dispensed. The additive volume may be selected as a cycle additive volume.

Although described primarily in the context of liquid volumes, it is understood that the above determinations or values may be determined in the context of estimated volumes or activation times (e.g., numbers of pulses) of the dispensing assembly. Thus, a set activation time or number of pulses may be known (e.g., from past or empirical determinations) to dispense a correlated or set volume of wash additive.

After the additive volume is determined, 660 may include dispensing the determined cycle additive volume within the wash tub. In other words, the dispensing assembly may be operated (e.g., as described above) to dispense the determined cycle additive volume. For example, continuing the example from above, the dispensing assembly may be used to provide flow of wash fluid into wash tub to facilitate various operating phases or cycles of washing machine appliance. More particularly, the dispensing assembly may dispense wash fluid that includes a mixture of water and the determined cycle additive volume (e.g., with or without other additives) during a wash phase or cycle.

Further rinse, agitation, or drain cycles may further be provided, as would be understood, until the washing operation is finished.

In some embodiments, the start of the wash cycle at 660 may be contingent on one or more predetermined conditions. As an example, it may be required that a user selects an input to start the wash cycle. As an additional or alternative example, it may be required that a door shuts within a predetermined time period (e.g., less than one minute, such as a period less than or equal to 30 seconds, 15 seconds, or 5 seconds) following 610 or 630 (e.g., measured in response to 610 or 630). For instance, the method 600 may include determining the door of the washing machine appliance is closed or in a closed position following the predetermined time period (e.g., following 610). Such as determination may be based on a signal from the latch assembly or a subsequently received image from the camera assembly. In turn, 660 may be in response to determining the door is closed within the predetermined time period. If the door is not determined to close within the predetermined time period (e.g., determination of the door being closed within the predetermined time period fails), a user may be required to manually input a start signal (e.g., by pressing a button) at the control panel of the washing machine appliance in order to prompt 660

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a washing machine appliance, the washing machine appliance comprising a cabinet, a wash tub, and a wash basket, the wash tub being mounted within the cabinet, and the wash basket being rotatably mounted within a wash tub and defining a wash chamber configured for receiving a load of clothes, the method comprising:
obtaining one or more images of a container in which a wash additive is stowed from a camera assembly of a remote device spaced apart from the cabinet;
determining a position of the remote device relative to the container;
analyzing an obtained image of the one or more images using an image recognition process to identify the wash additive; and
directing a wash cycle within the washing machine appliance based on the identified wash additive.

2. The method of claim 1, further comprising:
receiving a plurality of angle readings from the remote device;
wherein determining the position of the remote device is based on the plurality of angle readings;

3. The method of claim 2, wherein determining the position comprises determining a set camera angle for the camera assembly is met based on the determined position of the remote device, and
wherein analyzing the obtained image is contingent on determining the set camera angle is met.

4. The method of claim 3, further comprising:
selecting the obtained image in response to determining the set camera angle is met,
wherein analyzing the obtained image is in response to determining the set camera angle is met.

5. The method of claim 2, wherein the plurality of angle readings are detected at a measuring device fixed to the remote device.

6. The method of claim 5, wherein the measuring device comprises an accelerometer.

7. The method of claim 3, wherein obtaining one or more images comprises receiving a video signal from the camera assembly, and wherein the method further comprises:
presenting a real-time feed of the camera assembly at the remote device according to the received video signal; and
displaying movement guidance with the real-time feed to guide the remote device to the set camera angle.

8. The method of claim 1, wherein determining the position of the remote device is based on the one or more images.

9. The method of claim 8, wherein determining the position of the remote device comprises recognizing a set reference from the container.

10. The method of claim 1, wherein the image recognition process comprises at least one of an optical character recognition, a convolution neural network (“CNN”), a region-based convolution neural network (“R-CNN”), a deep belief network (“DBN”), a deep neural network (“DNN”), or a vision transformer (“ViT”) image recognition process.

11. A method of operating a washing machine appliance, the washing machine appliance comprising a cabinet, a wash tub, and a wash basket, the wash tub being mounted within the cabinet, and the wash basket being rotatably mounted within a wash tub and defining a wash chamber configured for receiving a load of clothes, the method comprising:
obtaining one or more images of a container in which a wash additive is stowed from a camera assembly of a remote device spaced apart from the cabinet, obtaining one or more images comprises receiving a video signal from the camera assembly;
determining a position of the remote device relative to the container;
presenting a real-time feed of the camera assembly at the remote device according to the received video signal;
displaying movement guidance with the real-time feed to guide the remote device;
analyzing an obtained image of the one or more images using an image recognition process to identify the wash additive subsequent to determining the position of the remote device; and
directing a wash cycle within the washing machine appliance based on the identified wash additive.

12. The method of claim 11, further comprising:
receiving a plurality of angle readings from the remote device;
wherein determining the position of the remote device is based on the plurality of angle readings;

13. The method of claim 12, wherein determining the position comprises determining a set camera angle for the camera assembly is met based on the determined position of the remote device, and
wherein analyzing the obtained image is contingent on determining the set camera angle is met.

14. The method of claim 13, further comprising:
selecting the obtained image in response to determining the set camera angle is met,
wherein analyzing the obtained image is in response to determining the set camera angle is met.

15. The method of claim 12, wherein the plurality of angle readings are detected at a measuring device fixed to the remote device.

16. The method of claim 15, wherein the measuring device comprises an accelerometer.

17. The method of claim 11, wherein determining the position of the remote device is based on the one or more images.

18. The method of claim 17, wherein determining the position of the remote device comprises recognizing a set reference from the container.

19. The method of claim 11, wherein the image recognition process comprises at least one of an optical character recognition, a convolution neural network (“CNN”), a region-based convolution neural network (“R-CNN”), a deep belief network (“DBN”), a deep neural network (“DNN”), or a vision transformer (“ViT”) image recognition process.
